(19) United States
(12) Patent Application Publication
(10) Pub. No.: US 2026/0003320 A1
(43) Pub. Date: Jan. 1, 2026

(54) IMAGE FORMING APPARATUS

(71) Applicant: CANON KABUSHIKI KAISHA, Tokyo (JP)

(72) Inventor: Takeshi Tsukahara, Shizuoka (JP)

(21) Appl. No.: 19/230,454

(22) Filed: Jun. 6, 2025

(30) Foreign Application Priority Data
Jun. 27, 2024 (JP) 2024-104487

(51) Int. Cl. G03G 21/16; G03G 15/08

(52) U.S. Cl. CPC G03G 21/1676; G03G 15/0875; G03G 15/0877; G03G 2215/068

(57) ABSTRACT

An image forming apparatus includes an apparatus body including a photosensitive drum, a developing container, and a developing roller, and a toner cartridge. The toner cartridge includes a toner storage chamber provided with a discharge port, a filter, and an air chamber provided with an inlet port. The apparatus body includes a restricting member configured to be movable in an intersecting direction between a restricting position and an allowing position, a connecting portion communicating with a first passage, and a pump. The restricting member includes a second passage through which the air supplied from the pump to the air chamber passes, engages with the inlet port to supply the air to the air chamber in a case where the restricting member is at the restricting position, and is separated from the inlet port to open the inlet port in a case where the restricting member is at the allowing position.

### BACKGROUND

### Field of the Technology

The present disclosure relates to an image forming apparatus that forms an image on a sheet.

### Description of the Related Art

According to Japanese Patent Application Laid-Open No. 2007-249151, an image forming apparatus including a developing portion configured to develop a photosensitive drum, a toner hopper configured to supply toner to the developing portion, and a powder supply apparatus configured to supply the toner to the toner hopper is proposed. The powder supply apparatus includes a powder storage portion configured to store the toner and a pump configured to suck in the toner stored in the powder storage portion and eject the toner toward the toner hopper. The powder storage portion and the pump are interconnected by a suction tube, and the pump and the toner hopper are interconnected by an ejection tube. The powder storage portion is configured to be replaceable.

In addition, in Japanese Patent Application Laid-Open No. 2023-62746, an image forming apparatus including a toner cartridge attachable to and detachable from an apparatus body, and a locking mechanism that locks the toner cartridge in the state of being attached to the apparatus body is proposed.

However, the locking mechanism described in Japanese Patent Application Laid-Open No. 2023-62746 is a dedicated mechanism for locking the toner cartridge, and causes increase in the cost due to increase in the number of parts.

### SUMMARY

According to a first aspect of the present disclosure, an image forming apparatus includes an apparatus body including a photosensitive drum configured to bear an electrostatic latent image, a developing container configured to store toner, and a developing roller configured to develop the electrostatic latent image into a toner image by using the toner in the developing container, and a toner cartridge configured to be attachable to and detachable from the apparatus body, the toner cartridge being attached to an attached position by being moved in an attachment direction, the toner cartridge being detached from the attached position by being moved in a detachment direction opposite to the attachment direction. The toner cartridge includes a toner storage chamber configured to store the toner and provided with a discharge port through which the toner is discharged to an outside of the toner cartridge, a filter configured to suppress passage of the toner and allow passage of air, and an air chamber partitioned from the toner storage chamber by the filter and provided with an inlet port communicating with the air chamber. The apparatus body includes a restricting member configured to be movable in an intersecting direction between a restricting position and an allowing position, the intersecting direction intersecting with the detachment direction, the restricting position being a position where the restricting member restricts movement of the toner cartridge in the detachment direction from the attached position by engaging with the inlet port of the toner cartridge, the allowing position being a position where the restricting member allows the movement of the toner cartridge in the detachment direction from the attached position, a connecting portion connected to the discharge port in a case where the toner cartridge is at the attached position, the connecting portion being communicating with a first passage through which the toner discharged from the toner cartridge and conveyed to the developing container passes, and a pump configured to supply the air to the air chamber of the toner cartridge through the inlet port and to discharge the toner in the toner storage chamber through the discharge port together with the air. The restricting member includes a second passage through which the air supplied from the pump to the air chamber passes, engages with the inlet port to supply the air to the air chamber in a case where the restricting member is at the restricting position, and is separated from the inlet port to open the inlet port in a case where the restricting member is at the allowing position.

According to a second aspect of the present disclosure, an image forming apparatus includes an apparatus body including a photosensitive drum configured to bear an electrostatic latent image, a developing container configured to store toner, and a developing roller configured to develop the electrostatic latent image into a toner image by using the toner in the developing container, and a toner cartridge configured to be attachable to and detachable from the apparatus body, the toner cartridge including a toner storage chamber configured to store the toner and provided with a discharge port through which the toner is discharged to an outside of the toner cartridge, a filter configured to suppress passage of the toner and allow passage of air, and an air chamber partitioned from the toner storage chamber by the filter and provided with an inlet port communicating with the air chamber. The apparatus body includes a restricting member configured to, in a case where the toner cartridge is at an attached position where the toner cartridge is attached to the apparatus body, restrict movement of the toner cartridge in a detachment direction from the attached position by engaging with the inlet port of the toner cartridge, a connecting portion connected to the discharge port in the case where the toner cartridge is at the attached position, the connecting portion being communicating with a first passage through which the toner discharged from the toner cartridge and conveyed to the developing container passes, and a pump configured to supply the air to the air chamber of the toner cartridge through the inlet port and to discharge the toner in the toner storage chamber through the discharge port together with the air. The restricting member includes a second passage through which the air supplied from the pump to the air chamber passes, and is separated from the inlet port to allow the movement of the toner cartridge in the detachment direction in response to movement of the toner cartridge in an intersecting direction intersecting with the detachment direction from the attached position.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic view of an image forming apparatus according to a first embodiment.

FIG. 2 is a perspective view of the image forming apparatus.

FIG. 3A is a section view illustrating a section 3A-3A of FIG. 1.

FIG. 3B is a section view illustrating a state in which a first pipe is detached from the toner cartridge.

FIG. 3C is a section view illustrating how the toner cartridge moves in a detachment direction.

FIG. 4A is an enlarged view of a portion of FIG. 3A indicated by a broken line.

FIG. 4B is an enlarged view of a portion of FIG. 3B indicated by a broken line.

FIG. 5 is a block diagram illustrating an example of a configuration of a control system according to the first embodiment.

FIG. 6 is a flowchart illustrating an example of control for driving a release mechanism.

FIG. 7 is a flowchart illustrating another example of control for driving a release mechanism.

FIG. 8 is a section view illustrating a configuration around a toner cartridge according to a second embodiment.

FIG. 9A is an enlarged view for describing an operation of an interlocking portion.

FIG. 9B is an enlarged view for describing an operation of the interlocking portion.

FIG. 10A is a section view illustrating a configuration around a toner cartridge according to a third embodiment.

FIG. 10B is a section view illustrating a state in which a door is open.

FIG. 10C is a section view illustrating how the toner cartridge moves in the detachment direction.

### DESCRIPTION OF THE EMBODIMENTS

### First Embodiment

### Overall Configuration

First, a first embodiment of the present disclosure will be described. The image forming apparatus 100 according to the first embodiment is a full-color laser beam printer of an electrophotographic system. To be noted, examples of the image forming apparatus include printers, copiers, facsimile machines, and multifunctional apparatuses, and the image forming apparatus refers to an apparatus that forms an image on a sheet used as a recording medium on the basis of image information input from an external personal computer (PC) or image information read from a document. In addition, in some cases, the image forming apparatus includes an additional device such as an optional feeder, an image reading apparatus, or a sheet processing apparatus coupled thereto in addition to a body having an image forming function, and the entire system including the additional device coupled thereto also serves as a kind of an image forming apparatus.

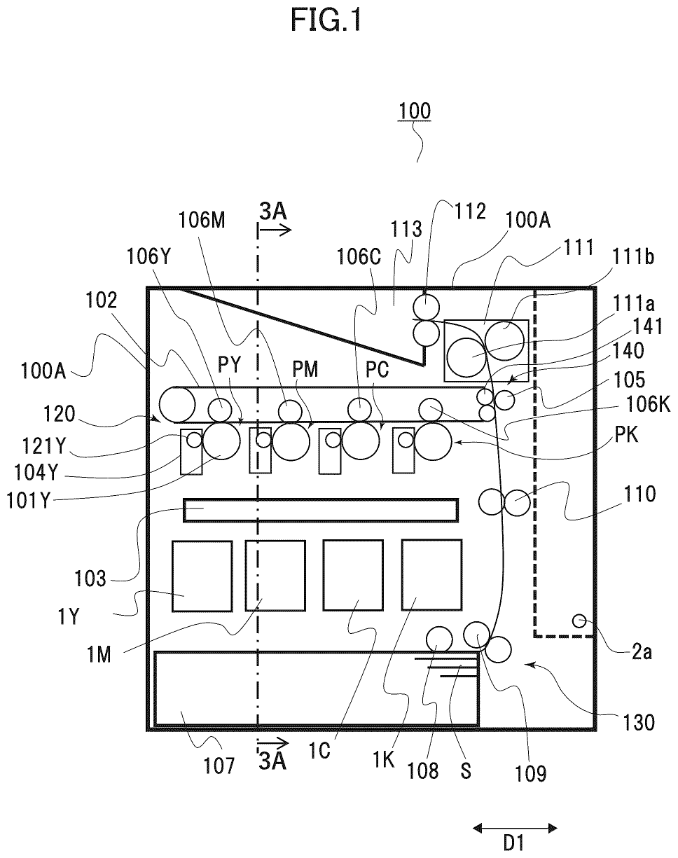

As illustrated in FIG. 1, the image forming apparatus 100 includes an image forming portion 120 that forms an image on a sheet S, a feeding unit 130, a fixing unit 111, and a discharge roller pair 112. The image forming portion 120 includes four process cartridges PY, PM, PC, and PK that respectively form toner images of four colors of yellow (Y), magenta (M), cyan (C), and black (K), and a laser scanner 103. The laser scanner 103 is disposed below the process cartridges PY, PM, PC, and PK. To be noted, a light emitting diode (LED) exposing unit may be used instead of the laser scanner 103.

To be noted, part of the image forming apparatus 100 excluding toner cartridges 1Y, 1M, 1C, and 1K may be referred to as a body of the image forming apparatus 100 or an apparatus body 100A. The process cartridges PY, PM, PC, and PK may be detachably supported with respect to the casing of the apparatus body 100A, and may be fixed to the casing of the apparatus body 100A so as not to be detachable.

In the present embodiment, suffices Y, M, C, and K are attached to reference signs of parts respectively corresponding to yellow, magenta, cyan, and black toners. The configurations and operations of the parts denoted with these suffices are substantially the same except that the color of the toner is different. Therefore, the description below may be given in a generalized manner by omitting the suffices Y to K in the case where no distinction is particularly required.

The process cartridge PY includes a photosensitive drum 101Y, an unillustrated charging roller, a developing container 104Y storing toner, and a developing roller 121Y. The photosensitive drum 101Y includes an aluminum cylinder and an organic photoconductor layer applied on the outer peripheral surface of the aluminum cylinder, and is rotated by an unillustrated driving motor. To be noted, a photosensitive belt may be used instead of the photosensitive drum 101Y. The developing container 104Y stores yellow toner, and the developing roller 121Y develops an electrostatic latent image on the photosensitive drum 101Y by using the toner in the developing container 104Y. The process cartridges PM, PC and PK each have substantially the same configuration as the process cartridge PY.

In addition, the image forming portion 120 is provided with an intermediate transfer belt unit 140 disposed above the process cartridges PY, PM, PC, and PK. The intermediate transfer belt unit 140 includes an intermediate transfer belt 102, primary transfer rollers 106Y, 106M, 106C, and 106K disposed on the inner peripheral side of the intermediate transfer belt 102, a secondary transfer inner roller 141, and a secondary transfer roller 105.

The primary transfer rollers 106Y, 106M, 106C, and 106K are in contact with the respective photosensitive drums of the process cartridges PY, PM, PC, and PK to form primary transfer portions. The secondary transfer roller 105 is disposed to oppose the secondary transfer inner roller 141 with the intermediate transfer belt 102 therebetween. The secondary transfer roller 105 and the intermediate transfer belt 102 are in contact with each other to form a secondary transfer portion.

The fixing unit 111 includes a fixing film 111a heated by a heater, and a pressurizing roller 111b that is in pressure contact with the fixing film 111a. The feeding unit 130 is provided in a lower portion of the image forming apparatus 100. The feeding unit 130 includes a feeding cassette 107 that can be drawn out from and attached to the apparatus body 100A, a pickup roller 108 that feeds the sheet S stored in the feeding cassette 107, and a conveyance roller pair 109. To be noted, examples of the sheet include paper such as paper sheets and envelopes, plastic films such as sheets for overhead projectors (OHP), and cloths.

### Image Forming Operation

Next, the image forming operation of the image forming apparatus 100 configured in this manner will be described. When an image signal is input to the laser scanner 103 from an unillustrated PC or the like, laser light corresponding to the image signal is radiated onto the surface of the photosensitive drum 101Y from the laser scanner 103.

At this time, the surface of the photosensitive drum 101Y is uniformly charged to a predetermined polarity and potential in advance by a charging roller, and an electrostatic latent image is formed on the surface as a result of the surface being irradiated with the laser light from the laser scanner 103. The electrostatic latent image borne on the photosensitive drum 101Y is developed by the developing roller 121Y, and thus a yellow (Y) toner image is formed on the photosensitive drum 101Y.

Similarly, magenta (M), cyan (C), and black (K) toner images are also formed on the respective photosensitive drums of the process cartridges PM, PC, and PK. The toner images of respective colors formed on the respective photosensitive drums are transferred onto the intermediate transfer belt 102 by the primary transfer rollers 106Y, 106M, 106C, and 106K, and are conveyed to the secondary transfer roller 105 by the intermediate transfer belt 102.

To be noted, the image forming process of each color is performed at a timing such that the toner image thereof is superimposed on an upstream toner image that has been already transferred onto the intermediate transfer belt 102 through primary transfer. In addition, after the toner images of the respective colors are transferred onto the intermediate transfer belt 102, toner remaining on the surface of each photosensitive drum is removed by an unillustrated cleaning apparatus.

In parallel with this image forming process, sheets S stored in the feeding cassette 107 of the feeding unit 130 are fed one by one by the pickup roller 108. Then, the sheet S is conveyed toward the secondary transfer portion by the conveyance roller pair 109 and a registration roller pair 110. The registration roller pair 110 may perform skew correction of the sheet S. For example, the skew of the sheet S is corrected by causing the sheet S to abut the nip of the registration roller pair 110 that is not operating. In addition, the conveyance roller pair 109 and the registration roller pair 110 control the conveyance speed of the sheet S, and thus the sheet S is conveyed at a timing matching the image conveyed by the intermediate transfer belt 102.

In the secondary transfer portion, the full-color toner image on the intermediate transfer belt 102 is transferred onto the sheet S by a secondary transfer bias applied to the secondary transfer roller 105. The sheet S onto which the toner image has been transferred is subjected to a predetermined heat and pressure from a fixing film 111a and a pressurizing roller 111b of a fixing unit 111, and thus the toner melts and adheres (is fixed). The sheet S having passed through the fixing unit 111 is discharged by the discharge roller pair 112, and is supported on a discharge tray 113 provided in an upper portion of the apparatus body 100A.

### Schematic Configuration of Toner Cartridge

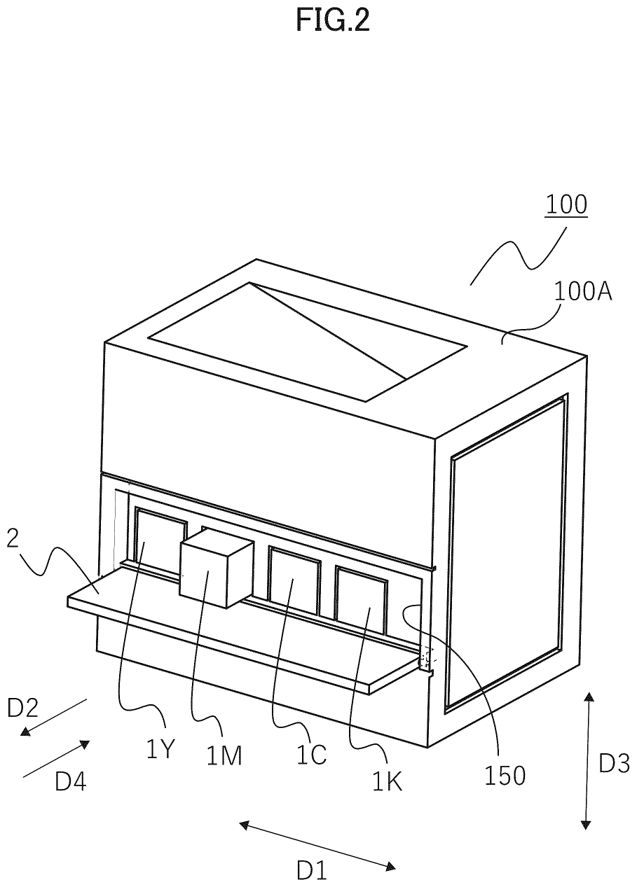

Next, a schematic configuration of the toner cartridges 1Y, 1M, 1C, and 1K will be described with reference to FIG. 2. FIG. 2 is a perspective view of the image forming apparatus 100. As illustrated in FIG. 2, the apparatus body 100A has an opening portion 150 provided in a casing of the apparatus body 100A and includes a door 2 capable of opening and closing the opening portion 150. The door 2 is configured to be movable (pivotable) about a pivot shaft 2a (see FIG. 1) to an open position where the door 2 opens the opening portion 150 and a closed position where the door 2 closes the opening portion 150, and is disposed on the front side of the image forming apparatus 100. In addition, the posture of the door 2 can be maintained at the closed position or the open position.

When the door 2 is opened from the closed position to the open position, the toner cartridges 1Y, 1M, 1C, and 1K are exposed to the outside of the image forming apparatus 100 through the opening portion 150. Therefore, the user can access the toner cartridges 1Y, 1M, 1C, and 1K. The toner cartridges 1Y, 1M, 1C, and 1K can replenish the developing containers 104 of the process cartridges PY, PM, PC, and PK with toner.

The toner cartridges 1Y, 1M, 1C, and 1K are arranged (aligned) in an arrangement direction D1. In addition, the process cartridges PY, PM, PC, and PK are also arranged in the arrangement direction D1 similarly to the toner cartridges 1Y, 1M, 1C, and 1K. The toner cartridges 1Y, 1M, 1C, and 1K are configured to be attachable to and detachable from the apparatus body 100A. That is, the toner cartridges 1Y, 1M, 1C, and 1K are moved in an attachment direction D4, and thus each reach an attached position where the toner cartridge is attached to the apparatus body 100A. In addition, the toner cartridges 1Y, 1M, 1C, and 1K are configured to be retracted from the attached position by being moved in a detachment direction D2 that is a direction opposite to the attachment direction D4. The attachment direction D4 and the detachment direction D2 each intersect with the arrangement direction D1. FIG. 2 illustrates how the toner cartridge 1M is detached from the apparatus body 100A in the detachment direction D2.

To be noted, as will be described in detail later, the toner cartridges 1Y, 1M, 1C, and 1K are configured to be detachable from the apparatus body 100A in the case where the toner remainder amount therein is equal to or less than a predetermined amount. In addition, a cartridge tray serving as a support member that is supported to be movable in the detachment direction D2 and the attachment direction D4 with respect to the apparatus body 100A and that supports the toner cartridges 1Y, 1M, 1C, and 1K may be provided. That is, the toner cartridges 1Y, 1M, 1C, and 1K may be configured to be simultaneously detached from the apparatus body 100A when the cartridge tray is drawn out in the detachment direction D2 from the apparatus body 100A.

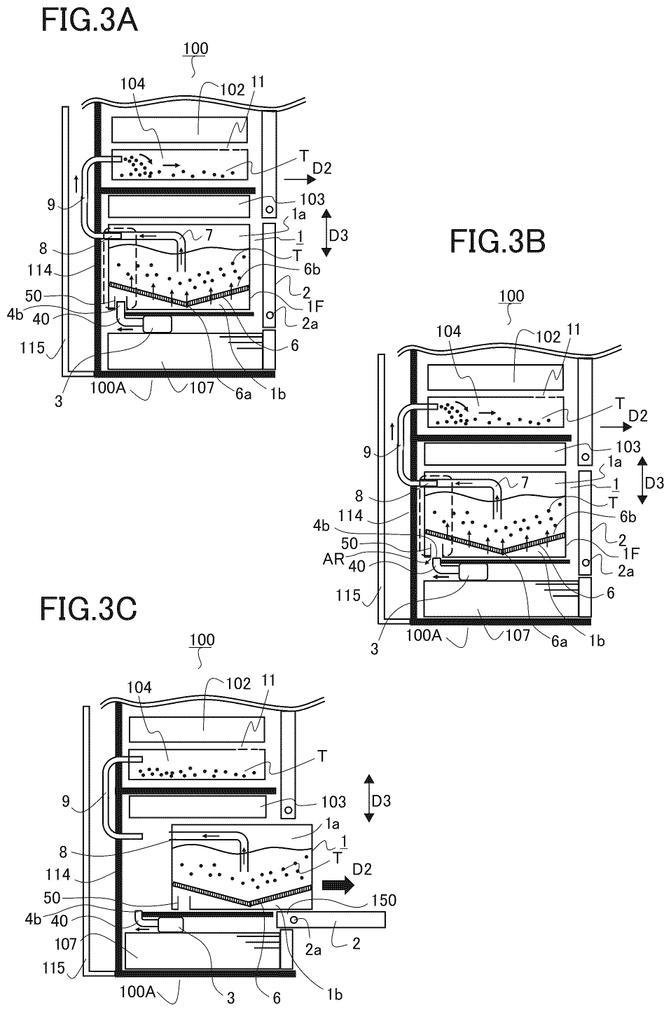

FIG. 3A is a section view illustrating a section 3A-3A of FIG. 1, FIG. 3B is a section view illustrating a state in which a first pipe 40 is detached from the toner cartridge 1, and FIG. 3C is a section view illustrating how the toner cartridge 1 moves in the detachment direction D2. To be noted, FIGS. 3B and 3C also illustrate the section 3A-3A of FIG. 1.

The toner cartridges 1Y, 1M, 1C, and 1K each have substantially the same configuration, and therefore these will be described as toner cartridges 1 without particular distinction in the description below. In addition, a pump 3, the first pipe 40, and a second pipe 9 are provided in the same number as the toner cartridges in the apparatus body 100A, and these will be also described without particular distinction.

As illustrated in FIG. 3A, the toner cartridge 1 includes a frame body 1F and a filter 6 fixed to the frame body 1F. The filter 6 partitions the inner space of the frame body 1F into a toner storage chamber 1a storing toner T and an air chamber 1b. That is, it can be said that the toner cartridge 1 includes the toner storage chamber 1a and the air chamber 1b. The air chamber 1b is disposed below the filter 6, and the toner storage chamber 1a is disposed above the filter 6.

The frame body 1F is formed from a resin material in the present embodiment, but may be formed from paper, rubber, or the like. In addition, the frame body 1F may be constituted by a plurality of members instead of a single member. For example, the frame body 1F may be constituted by two frame members sandwiching the filter 6. The filter 6 is constituted by, for example, a porous member formed from resin fiber. The pores of the filter 6 have such sizes and density as to allow passage of air but restrict passage of the toner T. That is, the filter 6 is configured to allow passage of air but suppress passage of the toner T. In addition, the filter 6 has a shape inclined toward a lowermost portion 6a that is positioned below an outer edge portion. That is, the filter 6 includes an inclined portion 6b that is inclined such that a portion thereof closer to the lowermost portion 6a in the horizontal direction is lower.

The apparatus body 100A includes a pump 3 for conveying air to the air chamber 1b of the toner cartridge 1, a first pipe 40, and a second pipe 9. The pump 3 is disposed below the toner cartridge 1. The apparatus body 100A includes a frame body 114 defining a space to accommodate the toner cartridge 1, and an exterior cover 115 is provided on the outside of the frame body 114. Part of the second pipe 9 extends through a space between the frame body 114 and the exterior cover 115. To be noted, the shapes of the first pipe 40 and the second pipe 9 are not limited. For example, the first pipe 40 and the second pipe 9 may be each formed in a shape having a circular shape or a rectangular shape in section view.

The first pipe 40 interconnects the pump 3 and the air chamber 1b, and conveys air from the pump 3 to the air chamber 1b. The second pipe 9 interconnects the toner storage chamber 1a and the developing container 104, and conveys toner from the toner storage chamber 1a to the developing container 104 together with air. More specifically, the toner cartridge 1 is provided with a first connected portion 50 and a second connected portion 8, and the first pipe 40 and the second pipe 9 are respectively connected to the first connected portion 50 and the second connected portion 8. In addition, the first pipe 40 is connected to the first connected portion 50 from the lower side of the toner cartridge 1. In other words, the first pipe 40 is connected to the toner cartridge 1 in an intersecting direction D3 intersecting with the detachment direction D2. The second pipe 9 is connected to the second connected portion 8 from the upstream side in the detachment direction D2 of the toner cartridge 1. In addition, the second pipe 9 is connected to the developing container 104 from the upstream side in the detachment direction D2.

The intersecting direction D3 of the present embodiment is a direction along the gravity direction, and the detachment direction D2 is a direction along the horizontal direction. The intersecting direction D3 and the detachment direction D2 are orthogonal to each other. To be noted, the intersecting direction D3 can be also referred to as a vertical direction or an up-down direction.

In addition, the toner storage chamber 1a is provided with a toner discharge pipe 7, and the toner T stored in the toner storage chamber 1a is conveyed to the developing container 104 in the apparatus body 100A through the toner discharge pipe 7, the second connected portion 8, and the second pipe 9. One end of the toner discharge pipe 7 opposes the lowermost portion 6a of the filter 6, and the other end thereof is connected to the second connected portion 8. To be noted, although the second connected portion 8 is integrally provided with the frame body 1F of the toner cartridge 1 and includes a pipe portion 8a interconnecting the toner discharge pipe 7 and the second pipe 9 in the present embodiment, the configuration is not limited to this. For example, the pipe portion 8a may be provided integrally with the toner discharge pipe 7 and engaged with the second pipe 9. In addition, the pipe portion 8a may be provided separately from the frame body 1F and the toner discharge pipe 7.

Next, a mechanism in which the toner Tis conveyed to the developing container 104 will be described. As a result of the operation of the pump 3, air is sent to the air chamber 1b through the first pipe 40. Then, this air fills the air chamber 1b and flows into the toner storage chamber 1a through the filter 6.

The air having flowed into the toner storage chamber 1a goes between particles of the toner T to fluidize the toner T. The pressure in the toner cartridge 1 becomes a positive pressure as a result of the flow-in of the air from the pump 3, and the air tries to get out of the toner cartridge 1 from the second connected portion 8 through the toner discharge pipe 7.

At this time, the toner T in the toner storage chamber 1a is moved through the toner discharge pipe 7 together with the air, and is discharged to the outside of the toner cartridge 1 from the second connected portion 8. That is, the toner discharge pipe 7 guides the toner T in the toner storage chamber 1a to the second connected portion 8 together with the air. The toner T discharged from the second connected portion 8 enters the developing container 104 through the second pipe 9. As a result of this, the developing container 104 is replenished with the toner T.

Since not only the toner T but also the air flows into the developing container 104, the inner pressure of the developing container 104 increases. Therefore, in the present embodiment, an exhaustion portion 11 is provided in the upper surface of the developing container 104. The exhaustion portion 11 is constituted by a through hole provided in the developing container 104 and an unillustrated exhaustion filter covering the through hole. The exhaustion filter is constituted by an unwoven fabric or the like, and is configured to allow passage of air and restrict passage of toner. As a result of this, discharge of the toner having flowed into the developing container 104 to the outside is restricted by the exhaustion filter, and the toner remains in the developing container 104. In contrast, at least part of the air having flowed into the developing container 104 is discharged to the outside of the developing container 104 through the exhaustion filter. As a result of this, the increase in the inner pressure of the developing container 104 is suppressed, and replenishment of the developing container 104 with toner can be performed smoothly.

### Detachment of Toner Cartridge

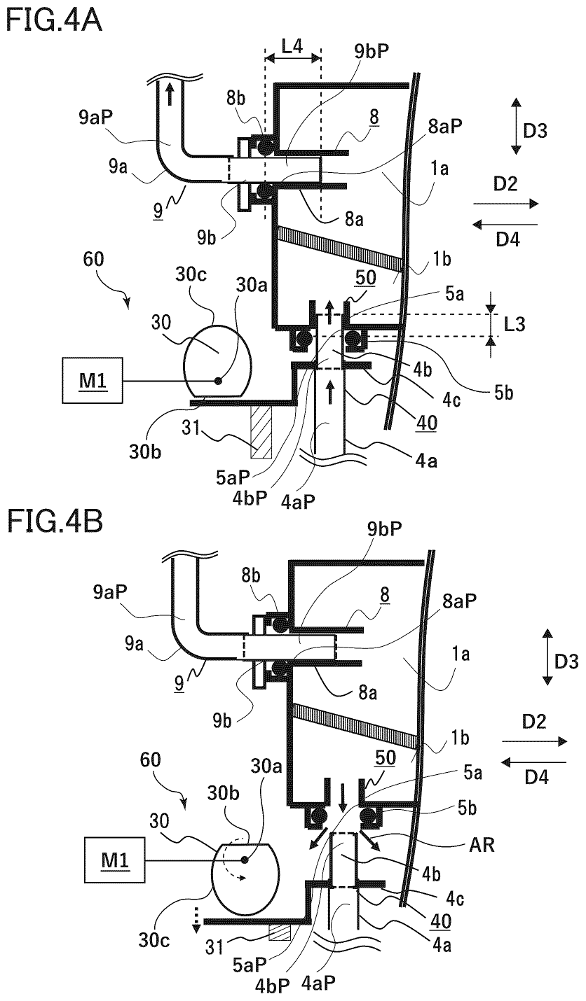

Next, elements for detaching the toner cartridge 1 from the apparatus body 100A and the detachment operation will be described with reference to FIGS. 3A to 4B. FIG. 4A is an enlarged view of a portion of FIG. 3A indicated by a broken line, and FIG. 4B is an enlarged view of a portion of FIG. 3B indicated by a broken line.

As illustrated in FIG. 4A, the first pipe 40 includes an air conveyance tube 4a, a first connecting portion 4b that communicates with the air conveyance tube 4a and that is inserted in the first connected portion 50, and a support member 4c. The support member 4c is fixed to at least one of the air conveyance tube 4a and the first connecting portion 4b. Therefore, the air conveyance tube 4a, the first connecting portion 4b, and the support member 4c are integrally formed. To be noted, the support member 4c may be guided by an unillustrated guide member so as to be movable in the intersecting direction D3. The air conveyance tube 4a includes a passage 4aP that the air supplied from the pump 3 passes through to be sent to the air chamber 1b. In addition, the first connecting portion 4b serving as a restricting member is formed in a tubular shape and includes a passage 4bP serving as a second passage that the air supplied from the pump 3 passes through to be sent to the air chamber 1b. That is, the air supplied from the pump 3 is sent from an inlet port 5aP to the air chamber 1b through the passages 4aP and 4bP.

The first connected portion 50 is formed integrally with the frame body 1F, and includes a pipe portion 5a defining the inlet port 5aP communicating with the air chamber 1b, and an O ring 5b that is in firm contact with the outer peripheral surface of the first connecting portion 4b. To be noted, it can be also said that the air chamber 1b is provided with the inlet port 5aP. The first connecting portion 4b of the first pipe 40 is inserted in the pipe portion 5a of the first connected portion 50 in the intersecting direction D3. That is, the first connecting portion 4b is connected to the inlet port 5aP of the pipe portion 5a. At this time, the O ring 5b serving as a first sealing member seals a gap between the first connecting portion 4b and the pipe portion 5a that is a part defining the inlet port 5aP.

The second pipe 9 includes a toner conveyance tube 9a and a second connecting portion 9b that communicates with the toner conveyance tube 9a and that is inserted in the second connected portion 8. The toner conveyance tube 9a includes a passage 9aP that the toner T discharged from the toner cartridge 1 through the second connecting portion 9b together with air passes through. In addition, the second connecting portion 9b is formed in a tubular shape, and includes a passage 9bP that the toner T discharged from the toner cartridge 1 together with air passes through. That is, the toner T discharged from the discharge port 8aP of the toner storage chamber 1a is sent to the developing container 104 through the passages 9bP and 9aP. The second connecting portion 9b serving as a connecting portion communicates with the passage 9aP serving as a first passage that the toner discharged from the toner cartridge 1 passes through to be conveyed to the developing container 104. In addition, the second connecting portion 9b is an example of a protruding portion protruding in the detachment direction D2, and the discharge port 8aP opens toward the attachment direction D4. To be noted, the entire second pipe 9 may be regarded as a connecting portion connected to the toner cartridge 1 positioned at the attached position. The passages 9bP and 9aP that the toner discharged from the toner cartridge 1 passes through to be conveyed to the developing container 104 are defined by the second pipe 9.

In addition, the second pipe 9 is disposed so as not to interfere with the laser optical path, other units of the image forming apparatus 100 such as the laser scanner 103 positioned between the toner cartridge 1 and the developing container 104, and the like. The second connected portion 8 is formed integrally with the frame body 1F, and includes a pipe portion 8a provided with a discharge port 8aP through which the toner T in the toner storage chamber 1a is discharged to the outside of the toner cartridge 1, and an O ring 8b that is in firm contact with the outer peripheral surface of the second connecting portion 9b. To be noted, it can be also said that the toner storage chamber 1a is provided with the discharge port 8aP. The second connecting portion 9b of the second pipe 9 is inserted in the pipe portion 8a of the second connected portion 8. That is, the second connecting portion 9b is connected to the discharge port 8aP of the pipe portion 8a. At this time, the O ring 8b serving as a second sealing member seals a gap between the second connecting portion 9b and the pipe portion 8a that is a part defining the discharge port 8aP.

To be noted, although the first connecting portion 4b is provided integrally with the air conveyance tube 4a in the present embodiment, the configuration is not limited to this. For example, the first connecting portion 4b may be constituted by a member different from the air conveyance tube 4a. In addition, the first connecting portion 4b may be directly connected to the pump 3 and the inlet port 5aP of the air chamber 1b. Similarly, although the second connecting portion 9b is provided integrally with the toner conveyance tube 9a in the present embodiment, the configuration is not limited to this. For example, the second connecting portion 9b may be constituted by a member different from the toner conveyance tube 9a. In addition, the second connecting portion 9b may be directly connected to the developing container 104 and the discharge port 8aP of the toner storage chamber 1a.

The first connected portion 50 is configured such that the first connecting portion 4b of the first pipe 40 is inserted in the air chamber 1b by just a first distance L3 serving as a predetermined distance from the O ring 5b in the intersecting direction D3 in the case where the toner cartridge 1 is at the attached position. That is, when the toner cartridge 1 is at the attached position, the second connecting portion 9b is inserted into the toner cartridge 1 through the discharge port 8aP. In addition, the second connected portion 8 is configured such that the second connecting portion 9b of the second pipe 9 is inserted into the toner storage chamber 1a by just a second distance L4 from the O ring 8b in the detachment direction D2 in the case where the toner cartridge 1 is at the attached position. At the attached position, the toner cartridge 1 is attached to the apparatus body 100A, and can convey the toner T toward the developing container 104.

As described above, in the present embodiment, the first pipe 40 and the second pipe 9 are respectively loosely inserted in the first connected portion 50 and the second connected portion 8, and the O rings 5b and 8b are respectively in firm contact with the outer peripheral surfaces of the first connecting portion 4b and the second connecting portion 9b. As a result of this, leakage of air from the first connected portion 50 and the second connected portion 8 can be suppressed.

In addition, the first connecting portion 4b engages with the inlet port 5aP of the toner cartridge 1 in the intersecting direction D3, and thus restricts the movement of the toner cartridge 1 positioned at the attached position in the detachment direction D2. In other words, the first connecting portion 4b engages with the toner cartridge 1 to position the toner cartridge 1 at the attached position.

As illustrated in FIGS. 4A and 4B, the apparatus body 100A includes a release mechanism 60 serving as a moving portion. The release mechanism 60 includes a cam 30 that rotates about a rotation shaft 30a, and a motor M1 that drives the cam 30. The cam 30 is disposed above the support member 4c, and the support member 4c is pressed by the cam 30 as a result of the rotation of the cam 30. In addition, a spring 31 is disposed below the support member 4c, and the spring 31 presses the support member 4c upward.

For example, the cam 30 is configured to be movable to a first position illustrated in FIG. 4A, and a second position illustrated in FIG. 4B. The cam 30 includes a flat surface 30b formed in a linear shape, and a cam surface 30c that is a curved surface. The cam 30 abuts the support member 4c by the flat surface 30b when at the first position illustrated in FIG. 4A. At this time, the support member 4c is pressed against the flat surface 30b by the spring 31. In addition, the first connecting portion 4b is positioned at the restricting position where the first connecting portion 4b engages with the inlet port 5aP of the toner cartridge 1. At the restricting position, the first connecting portion 4b restricts the movement of the toner cartridge 1 in the detachment direction D2 from the attached position.

In contrast, the cam 30 abuts the support member 4c by the cam surface 30c when at the second position illustrated in FIG. 4B. The cam 30 pushes down the support member 4c in the intersecting direction D3 against the urging force of the spring 31 when rotating from the first position to the second position. As a result of this, the first pipe 40 is pushed down in the intersecting direction D3, and the first connecting portion 4b is separated from the inlet port 5aP. At this time, the first connecting portion 4b is positioned at the allowing position where movement of the toner cartridge 1 in the detachment direction D2 from the attached position is allowed. As described above, the first connecting portion 4b is configured to be movable between the restricting position and the allowing position in the intersecting direction D3 intersecting with the detachment direction D2 by the release mechanism 60. As a result of the first connecting portion 4b separating from the inlet port 5aP to open the inlet port 5aP, the inlet port 5aP communicates with the outside of the toner cartridge 1, and the inner pressure of the toner cartridge 1 becomes approximately equal to the atmospheric pressure. That is, the inner pressure of the air chamber 1b of the toner cartridge 1 is approximately equal to the atmospheric pressure when the first connecting portion 4b is positioned at the allowing position.

To be noted, for example, the first pipe 40 including the first connecting portion 4b has flexibility, and the first pipe 40 can be individually moved downward without changing the position of the pump 3. In addition, the pump 3 may be configured to move downward together with the first pipe 40.

For example, in the case where clogging occurs at some point in the toner conveyance path from the toner cartridge 1 to the developing container 104, the inner pressure of the toner cartridge 1 can be higher than the atmospheric pressure. Further, when the first connecting portion 4b is detached from the first connected portion 50 in a state in which the inner pressure of the toner cartridge 1 is higher than the atmospheric pressure, the air AR is discharged from the first connected portion 50 to the outside of the toner cartridge 1 until the inner pressure of the toner cartridge 1 is approximately equal to the atmospheric pressure.

As illustrated in FIG. 3C, when detaching the toner cartridge 1 from the apparatus body 100A, the user first moves the door 2 from the closed position to the open position. Then, the user draws out the toner cartridge 1 from the apparatus body 100A in the detachment direction D2. At this time, the toner cartridge 1 is drawn out while being supported by the upper surface of the door 2. Further, as a result of detaching the second connecting portion 9b from the toner cartridge 1, the toner cartridge 1 is detached from the apparatus body 100A. The toner cartridge 1 can be replaced in this manner.

In addition, the engagement between the first connecting portion 4b and the first connected portion 50 of the toner cartridge 1 is released by the release mechanism 60 described above before the toner cartridge 1 is drawn out in the detachment direction D2. In other words, the toner cartridge 1 is configured such that the connection thereof to the first connecting portion 4b is released before the connection thereof to the second connecting portion 9b is released. As a result of this, when the second connecting portion 9b is detached from the toner cartridge 1, the inner pressure of the toner cartridge 1 has been already reduced to be approximately equal to the atmospheric pressure, and thus the toner T in the toner storage chamber 1a does not jet out from the second connected portion 8. Therefore, toner leakage when replacing the toner cartridge 1 can be suppressed.

In addition, the movement of the toner cartridge 1 in the detachment direction D2 is restricted in a state in which the first connecting portion 4b is engaged with the first connected portion 50, and therefore the toner leakage can be suppressed reliably. Further, the first connecting portion 4b includes the passage 4bp that the air supplied from the pump 3 passes through to be sent to the air chamber 1b, and is engaged with the inlet port 5aP to supply the air to the air chamber when at the restricting position. As described above, the first connecting portion 4b of the present embodiment has two functions of positioning the toner cartridge 1 in the detachment direction D2 and conveying air to the toner cartridge 1. Therefore, the number of parts can be reduced as compared with a case where an element for positioning (locking) the toner cartridge 1 in the detachment direction D2 is additionally provided, and thus the cost can be reduced. That is, the cost can be reduced while configuring the toner cartridge 1 to be capable of being positioned at the attached position.

To be noted, although there are various methods to detach the toner cartridge 1 in the detachment direction D2 from the apparatus body 100A, the method is not limited thereto. For example, the toner cartridge 1 may be detached from the apparatus body 100A by the user pulling an unillustrated gripping portion of the toner cartridge 1. In addition, a configuration in which a push-out mechanism to push out the toner cartridge 1 to the outside of the apparatus body 100A is provided in the apparatus body 100A and the toner cartridge 1 is moved in the detachment direction D2 when the door 2 is moved from the closed position to the open position may be employed. For the push-out mechanism, for example, an urging force of a spring can be used, or an actuator such as a solenoid can be used.

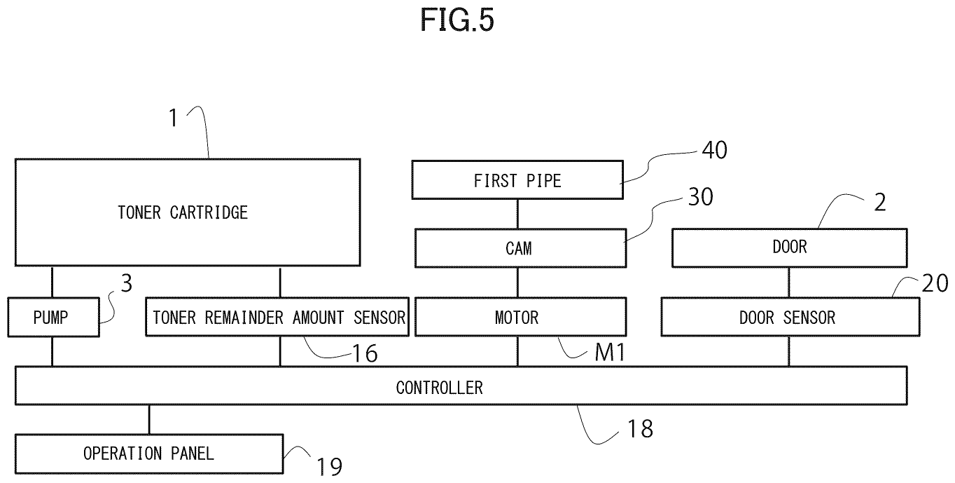

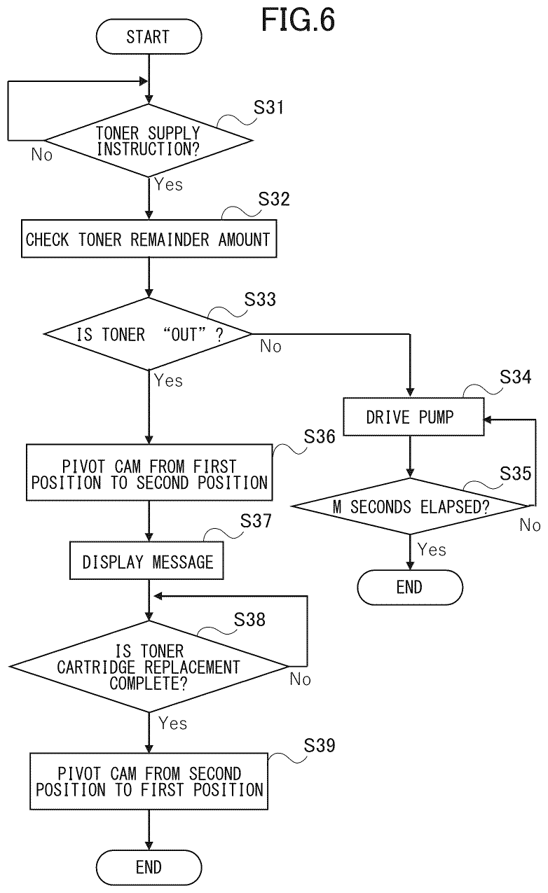

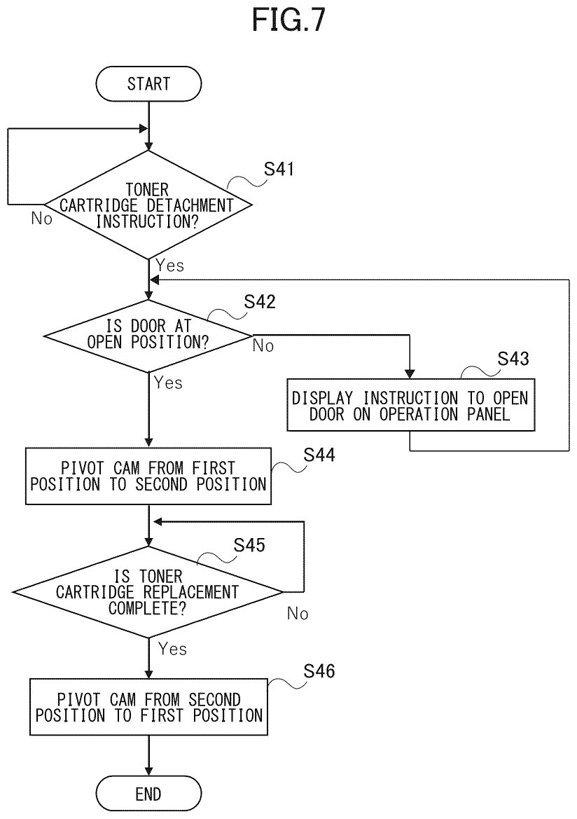

Here, a control example for driving the release mechanism 60 will be described with reference to FIGS. 5 to 7. FIG. 5 is a block diagram illustrating a configuration of a control system according to the present embodiment. FIG. 6 is a flowchart illustrating an example of control for driving the release mechanism 60. FIG. 7 is a flowchart illustrating another example of control for driving the release mechanism 60. As illustrated in FIG. 5, the image forming apparatus 100 (see FIG. 1) includes a controller 18, and the controller 18 is connected to a pump 3, a toner remainder amount sensor 16, a motor M1, a door sensor 20, and an operation panel 19.

The toner remainder amount sensor 16 can detect the remainder amount of the toner T stored in the toner storage chamber 1a of the toner cartridge 1. That is, the toner remainder amount sensor 16 outputs a signal corresponding to the remainder amount of the toner stored in the toner cartridge 1. For example, the toner remainder amount sensor 16 is constituted by an optical sensor including a light emitting portion and a light receiving portion, and an optical path between the light emitting portion and the light receiving portion is set to extend in the toner storage chamber 1a. Further, the toner remainder amount in the toner storage chamber 1a is detected in accordance with, for example, a time in which the optical path is blocked by the toner T.

The door sensor 20 detects the opening/closing state of the door 2. That is, the door sensor 20 outputs a signal that differs between a case where the door 2 is at the closed position and a case where the door 2 is at the open position. An operation panel 19 serving as an operation portion includes, for example, a touch panel, and is capable of outputting various signals to the controller 18 in response to operation thereon by a user. In addition, the controller 18 is connected to the motor M1, and the first pipe 40 is inserted into or separated from the toner cartridge 1 by driving the cam 30 by the motor M1.

Next, the flowchart illustrated in FIG. 6 will be described. The flowchart illustrated in FIG. 6 illustrates movement control of the first pipe 40 in the case where the toner remainder amount in the toner storage chamber 1a is small. To be noted, at the start of the flowchart of FIG. 6, the first pipe 40 is inserted in the first connected portion 50 of the toner cartridge 1, and thus detachment of the toner cartridge 1 from the apparatus body 100A is restricted by the first pipe 40. That is, the cam 30 is positioned at the first position.

As illustrated in FIG. 6, the controller 18 first determines whether or not a toner supply instruction to supply the toner T from the toner cartridge 1 to the developing container 104 has been input (S31).

In the case where it is determined that the toner supply instruction has been input (S31: Yes), the controller 18 checks the toner remainder amount in the toner storage chamber 1a by using the toner remainder amount sensor 16 (S32). Next, the controller 18 determines whether or not the toner remainder amount in the toner storage chamber 1a is “out” (S33). To be noted, a state in which the toner remainder amount is “out” refers to a state in which the toner in the toner storage chamber 1a is equal to or less than a predetermined threshold value, that is, equal to or less than a predetermined amount. The threshold value may be set to an arbitrary value, and the “out” state does not necessarily indicate that there is no toner in the toner storage chamber 1a. The controller 18 determines that the toner remainder amount is “out” by obtaining a signal corresponding to a toner remainder amount of a predetermined amount or less from the toner remainder amount sensor 16.

In the case where it has been determined that the toner remainder amount in the toner storage chamber 1a is not “out” (S33: No), the controller 18 drives the pump 3 (S34). Then, the controller 18 determines whether or not M seconds have passed since the driving of the pump 3 is started (S35). In the case where it is determined that M seconds have passed (S35: Yes), the control is finished. To be noted, M seconds is an arbitrary time required for replenishing the developing container 104 with the toner T, and as a result of the pump 3 being driven for M seconds, the toner T is normally supplied to the developing container 104.

In contrast, in the case where it is determined in step S33 that the toner remainder amount in the toner storage chamber 1a is “out” (S33: Yes), the controller 18 performs drive control of the motor M1 to rotate the cam 30 from the first position to the second position (S36). As a result of this, the first pipe 40 is separated from the toner cartridge 1, and it becomes possible to detach the toner cartridge 1 from the apparatus body 100A. Next, the controller 18 displays a message on the operation panel 19 (S37). The message includes, for example, contents prompting the user to replace the toner cartridge 1, or contents prompting the user to open the door 2. To be noted, an image or a diagram indicating the contents described above may be displaced on the operation panel 19 instead of the message, or a sound indicating the contents described above may be output. To be noted, step S37 may be omitted.

Next, the controller 18 determines whether or not the replacement of the toner cartridge 1 has been completed (S38). The completion of the replacement of the toner cartridge 1 is determined in accordance with, for example, detection results of the toner remainder amount sensor 16 and the door sensor 20. That is, it is determined that the replacement of the toner cartridge 1 is completed in the case where increase in the toner remainder amount in the toner storage chamber 1a is detected by the toner remainder amount sensor 16 or the case where movement of the door 2 from the open position to the closed position is detected by the door sensor 20. As described above, when detaching the toner cartridge 1 from the apparatus body 100A, the inner pressure of the toner cartridge 1 has become approximately equal to the atmospheric pressure in step S36, therefore the toner T in the toner storage chamber 1a does not jet out from the second connected portion 8, and toner leakage in the case of replacing the toner cartridge 1 can be suppressed.

Then, in the case where it is determined that the replacement of the toner cartridge 1 has been completed (S38: Yes), the controller 18 performs drive control of the motor M1 to rotate the cam 30 from the second position to the first position (S39). As a result of this, the first pipe 40 engages with the toner cartridge 1, and thus the toner cartridge 1 is positioned at the attached position. The control is finished in this manner.

Next, a flowchart illustrated in FIG. 7 will be described. The flowchart illustrated in FIG. 7 illustrates movement control of the first pipe 40 in the case where a toner cartridge detachment instruction is output from the operation panel 19. In this control, a sufficient amount of the toner T may remain in the toner storage chamber 1a of the toner cartridge 1. To be noted, at the start of the flowchart of FIG. 7, the first pipe 40 is inserted in the first connected portion 50 of the toner cartridge 1, and thus the detachment of the toner cartridge 1 from the apparatus body 100A is restricted by the first pipe 40. That is, the cam 30 is positioned at the first position.

As illustrated in FIG. 7, the controller 18 first determines whether or not a toner cartridge detachment instruction output from the operation panel 19 has been input (S41). The toner cartridge detachment instruction is a signal instructing to detach the toner cartridge. In the case where it is determined that the toner cartridge detachment instruction has been input (S41: Yes), the controller 18 determines whether or not the door 2 is at the open position on the basis of a detection result of the door sensor 20 (S42). The controller 18 determines that the door 2 is at the open position by obtaining a signal corresponding to the door 2 positioned at the open position from the door sensor 20. In the case where it is determined that the door 2 is not at the open position (S42: No), the controller 18 causes a panel of the operation panel 19 to display an instruction prompting the user to open the door 2 (S43), and returns to step S42.

In the case where it is determined that the door 2 is at the open position in step S42 (S42: Yes), the controller 18 performs drive control of the motor M1 to rotate the cam 30 from the first position to the second position (S44). The control below (S45, S46) is substantially the same as steps S38 and S39 of FIG. 6 described above, and therefore description thereof will be omitted.

To be noted, although the controller 18 confirms that the door 2 is positioned at the open position in step S42 in the present embodiment, the configuration is not limited to this. For example, step S42 may be omitted, and the cam 30 may be rotated from the first position to the second position immediately after the input of the toner cartridge detachment instruction. In addition, although the controller 18 confirms whether or not the toner cartridge detachment instruction from the operation panel 19 is input in step S41 in the present embodiment, the configuration is not limited to this. For example, step S41 may be omitted, and the cam 30 may be rotated from the first position to the second position on the basis of the door 2 being positioned at the open position.

In addition, although the cam 30 is rotated from the first position to the second position on the basis of determination that the toner remainder amount is “out” (S33: Yes) in the flowchart of FIG. 6, the configuration is not limited to this. For example, the cam 30 may be rotated from the first position to the second position on the basis of the message of step S37 being displayed and the door 2 positioned at the open position being detected by the door sensor 20.

### Second Embodiment

A second embodiment of the present disclosure will be described next. The second embodiment is configured by providing an interlocking portion 61 instead of the release mechanism 60 of the first embodiment. Therefore, elements substantially the same as in the first embodiment will be omitted from illustration, or denoted by the same reference signs in the drawings for description.

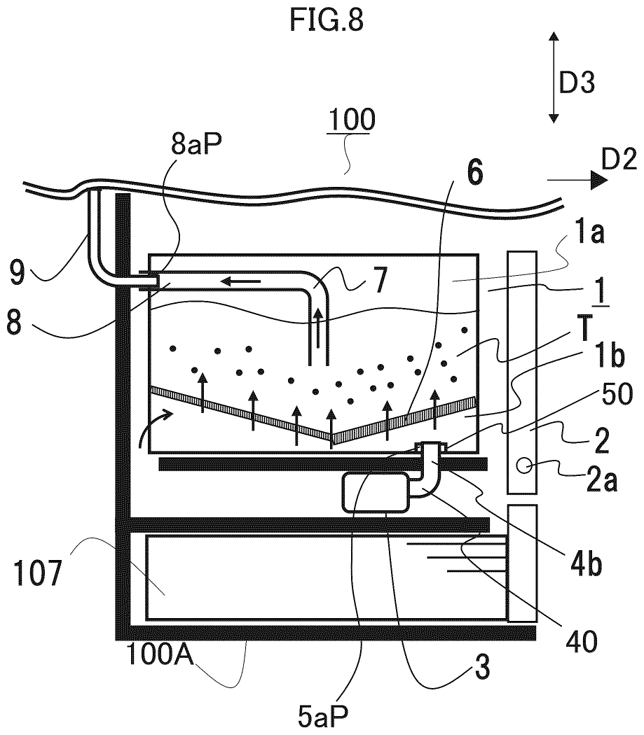

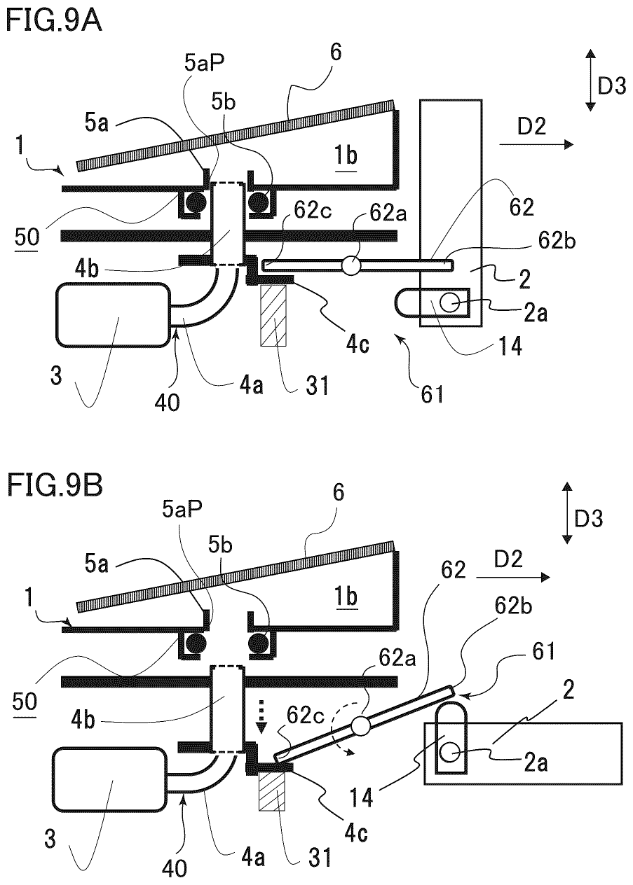

FIG. 8 is a section view illustrating a configuration around the toner cartridge 1 according to the second embodiment. FIG. 8 illustrates the same cross-section as the section 3A-3A of FIG. 1. FIGS. 9A and 9B are each an enlarged view for describing the operation of the interlocking portion 61. As illustrated in FIG. 8, the first pipe 40 of the present embodiment is provided to extend below the toner cartridge 1 and on the downstream side of the pump 3 in the detachment direction D2 to position the first pipe 40 close to the interlocking portion 61 that is disposed near the door 2 and that will be described later.

As illustrated in FIG. 9A, the interlocking portion 61 is disposed between the door 2 and the first pipe 40. The interlocking portion 61 includes a link arm 14, a link lever 62, and a spring 31. The link arm 14 is fixed to the door 2, and pivots about a pivot shaft 2a integrally with the door 2 pivoting about the pivot shaft 2a. The link lever 62 is configured to be pivotable about a pivot shaft 62a, and includes a first end portion 62b capable of abutting the link arm 14, and a second end portion 62c capable of abutting the support member 4c of the first pipe 40. The first end portion 62b and the second end portion 62c are provided on opposite sides with the pivot shaft 62a therebetween.

As illustrated in FIG. 9A, when the door 2 is positioned at the open position, the link arm 14 is separated from the link lever 62. At this time, the first connecting portion 4b of the first pipe 40 is at the restricting position, and is engaged with the inlet port 5aP of the toner cartridge 1. That is, the movement of the toner cartridge 1 in the detachment direction D2 is restricted by the first connecting portion 4b positioned at the restricting position.

Further, as illustrated in FIG. 9B, when the door 2 moves from the closed position to the open position, the link arm 14 that pivots integrally with the door 2 presses the first end portion 62b of the link lever 62 upward, and thus the link lever 62 pivots about the pivot shaft 62a. At this time, the link lever 62 pivots in the counterclockwise direction of FIG. 9B about the pivot shaft 62a.

As a result of the link lever 62 pivoting in the counterclockwise direction about the pivot shaft 62a, the second end portion 62c of the link lever 62 presses the support member 4c downward against the urging force of the spring 31. As a result of this, the first pipe 40 is pushed down in the intersecting direction D3, and the first connecting portion 4b is separated from the inlet port 5aP. At this time, the first connecting portion 4b is at the allowing position to allow the movement of the toner cartridge 1 in the detachment direction D2 from the attached position. In this manner, the first connecting portion 4b is configured to be movable between the restricting position and the allowing position by the interlocking portion 61 in the intersecting direction D3 intersecting with the detachment direction D2. As a result of separating the first connecting portion 4b from the inlet port 5aP to open the inlet port 5aP, the inlet port 5aP communicates with the outside of the toner cartridge 1, and thus the inner pressure of the toner cartridge 1 becomes approximately equal to the atmospheric pressure.

As a result of this, an effect similar to that of the first embodiment can be obtained. In addition, in the present embodiment, the first connecting portion 4b moves from the restricting position to the allowing position as a result of the door 2 being moved from the closed position to the open position by the interlocking portion 61, and is thus detached from the toner cartridge 1. Therefore, an actuator such as a motor is not necessary, and thus the cost can be reduced.

To be noted, although the link lever 62 is configured to pivot about the pivot shaft 62a in conjunction with the door 2, the configuration is not limited to this. For example, the link lever 62 may be configured to slide in the intersecting direction D3.

### Third Embodiment

A third embodiment of the present disclosure will be described next. The third embodiment is configured by providing the toner cartridge 1 with a gripping portion 63 instead of the release mechanism 60 of the first embodiment. Therefore, elements substantially the same as in the first embodiment will be omitted from illustration, or denoted by the same reference signs in the drawings for description.

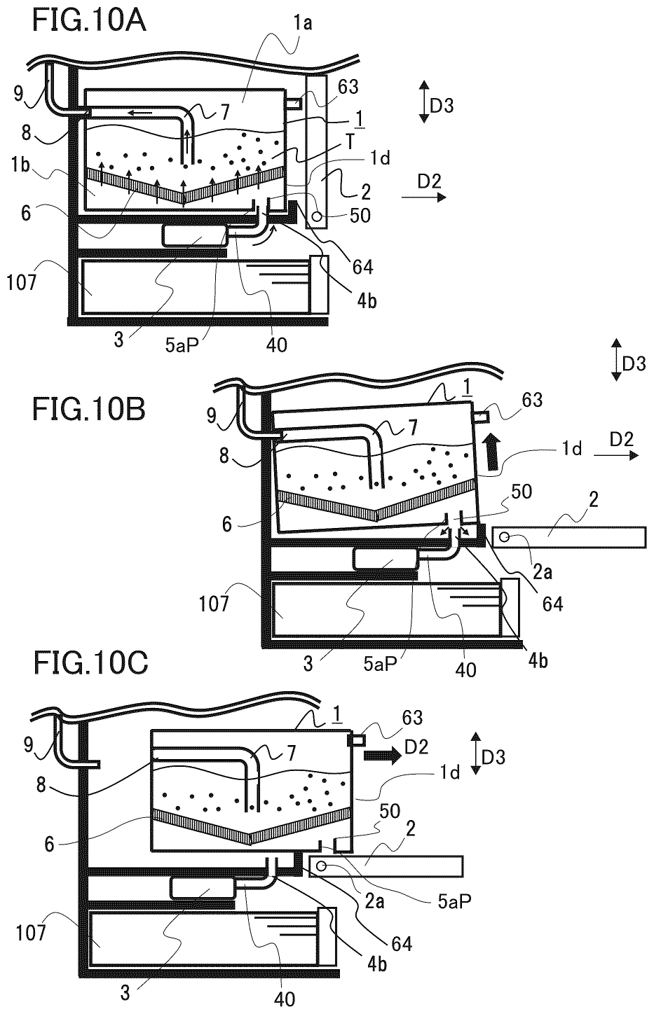

FIG. 10A is a section view illustrating a configuration around the toner cartridge 1 according to the third embodiment. FIG. 10B is a section view illustrating a state in which the door 2 is open, and FIG. 10C is a section view illustrating how the toner cartridge 1 moves in the detachment direction D2. To be noted, FIGS. 10A, 10B, and 10C illustrate the same cross-section as the section 3A-3A of FIG. 1.

As illustrated in FIG. 10A, the toner cartridge 1 according to the third embodiment is provided with the gripping portion 63. The gripping portion 63 is disposed in a side surface 1d serving as a surface facing in the detachment direction D2 of the toner cartridge 1 to protrude in the detachment direction D2 from the side surface 1d. In addition, the gripping portion 63 is disposed to oppose the door 2 positioned at the closed position. As a result of providing the gripping portion 63 in this manner, a user can access the gripping portion 63 by opening the door 2. When the toner cartridge 1 is at the attached position, the first connecting portion 4b is engaged with the inlet port 5aP to restrict the movement of the toner cartridge 1 from the attached position to the detachment position in the detachment direction D2.

As illustrated in FIG. 10B, when detaching the toner cartridge 1 from the apparatus body 100A, the user first moves the door 2 from the closed position to the open position. Then, the user operates the gripping portion 63 to lift up the gripping portion 63, and thus pivots the side surface 1d side of the toner cartridge 1 upward. At this time, the inlet port 5aP of the toner cartridge 1 is separated from the first connecting portion 4b. As a result of the detachment of the first pipe 40 from the first connected portion 50, the first connected portion 50 communicates with the outside of the toner cartridge 1, and thus the inner pressure of the toner cartridge 1 becomes approximately equal to the atmospheric pressure. The position of the toner cartridge 1 where the inlet port 5aP is detached from the first connecting portion 4b in the process of lifting up the gripping portion 63 as described above will be referred to as a moved position. The moved position is a position to which the toner cartridge 1 has been moved upward by just a predetermined detachment distance from the attached position. The detachment distance may be approximately equal to or longer than the distance L3 (see FIG. 4A).

In addition, in the present embodiment, a restricting portion 64 is provided between the door 2 and the toner cartridge 1 positioned at the attached position. The restricting portion 64 restricts the movement of the toner cartridge 1 in the detachment direction D2 when the toner cartridge 1 is positioned between the attached position and the moved position.

The user can move the toner cartridge 1 in the detachment direction D2 beyond the restricting portion 64 by further lifting up the toner cartridge 1 from the moved position. That is, as a result of the toner cartridge 1 being moved in the intersecting direction D3 from the attached position to the moved position, the first connecting portion 4b is separated from the inlet port 5aP and allows the movement of the toner cartridge 1 in the detachment direction D2. Then, the restricting portion 64 guides the toner cartridge 1 moving in the detachment direction D2 from the moved position.

As a result of this configuration, a similar effect to the first embodiment can be obtained. In addition, the restricting portion 64 guides the toner cartridge 1 being drawn out in the detachment direction D2 after the first connecting portion 4b is separated from the inlet port 5aP of the toner cartridge 1, and thus the interference between the toner cartridge 1 and the first connecting portion 4b can be suppressed. As a result of this, damage and breakage of the first connecting portion 4b can be suppressed.

### OTHER EMBODIMENTS

To be noted, although the first pipe 40 including the first connecting portion 4b is pushed down by the release mechanism 60 and the interlocking portion 61 in the first embodiment and the second embodiment, the configuration is not limited to this. That is, the release mechanism 60 and the interlocking portion 61 may be configured to be capable of separating the first connecting portion 4b and the inlet port 5aP of the toner cartridge 1 from each other in the intersecting direction D3. Therefore, the release mechanism 60 and the interlocking portion 61 may be configured to move at least one of the first connecting portion 4b and the toner cartridge 1 to be separated from the other in the intersecting direction D3. For example, the release mechanism 60 and the interlocking portion 61 may be configured to cancel the engagement between the inlet port 5aP of the toner cartridge 1 and the first connecting portion 4b by moving the toner cartridge 1 in the intersecting direction D3. In addition, the release mechanism 60 and the interlocking portion 61 may be configured to separate both of the first connecting portion 4b and the toner cartridge 1 from each other in the intersecting direction D3.

In addition, although the first connecting portion 4b is connected to the toner cartridge 1 from the lower side in all the embodiments described above, the configuration is not limited to this. For example, the first connecting portion 4b may be connected to the toner cartridge 1 from the upper side. In addition, the first connecting portion 4b may be connected to the toner cartridge 1 in the arrangement direction D1 (see FIG. 2). That is, the arrangement direction D1 may be an example of the intersecting direction.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-104487, filed Jun. 27, 2024, which is hereby incorporated by reference herein in its entirety.

What is claimed is:

1. An image forming apparatus comprising:
an apparatus body including:
a photosensitive drum configured to bear an electrostatic latent image;
a developing container configured to store toner; and
a developing roller configured to develop the electrostatic latent image into a toner image by using the toner in the developing container; and
a toner cartridge configured to be attachable to and detachable from the apparatus body, the toner cartridge being attached to an attached position by being moved in an attachment direction, the toner cartridge being detached from the attached position by being moved in a detachment direction opposite to the attachment direction,
wherein the toner cartridge includes:
a toner storage chamber configured to store the toner and provided with a discharge port through which the toner is discharged to an outside of the toner cartridge;
a filter configured to suppress passage of the toner and allow passage of air; and
an air chamber partitioned from the toner storage chamber by the filter and provided with an inlet port communicating with the air chamber,
wherein the apparatus body includes:
a restricting member configured to be movable in an intersecting direction between a restricting position and an allowing position, the intersecting direction intersecting with the detachment direction, the restricting position being a position where the restricting member restricts movement of the toner cartridge in the detachment direction from the attached position by engaging with the inlet port of the toner cartridge, the allowing position being a position where the restricting member allows the movement of the toner cartridge in the detachment direction from the attached position;
a connecting portion connected to the discharge port in a case where the toner cartridge is at the attached position, the connecting portion being communicating with a first passage through which the toner discharged from the toner cartridge and conveyed to the developing container passes; and
a pump configured to supply the air to the air chamber of the toner cartridge through the inlet port and to discharge the toner in the toner storage chamber through the discharge port together with the air, and
wherein the restricting member includes a second passage through which the air supplied from the pump to the air chamber passes, engages with the inlet port to supply the air to the air chamber in a case where the restricting member is at the restricting position, and is separated from the inlet port to open the inlet port in a case where the restricting member is at the allowing position.

2. The image forming apparatus according to claim 1, further comprising a sealing member configured to seal a gap between the restricting member and a portion constituting the inlet port in a state in which the restricting member is engaged with the inlet port.

3. The image forming apparatus according to claim 2, wherein the restricting member is inserted into the toner cartridge toward the air chamber by a predetermined distance from the sealing member in the intersecting direction in a case where the toner cartridge is positioned at the attached position and the restricting member is positioned at the restricting position.

4. The image forming apparatus according to claim 2, wherein an inner pressure of the air chamber of the toner cartridge is approximately equal to atmospheric pressure in a case where the restricting member is positioned at the allowing position.

5. The image forming apparatus according to claim 1, wherein the toner discharged from the toner cartridge through the discharge port is conveyed to the developing container through the second passage by the air supplied by the pump.

6. The image forming apparatus according to claim 1, wherein the connecting portion is a protruding portion protruding in the detachment direction,
wherein the discharge port opens toward the attachment direction, and
wherein the protruding portion is inserted into the toner cartridge through the discharge port in a case where the toner cartridge is at the attached position.

7. The image forming apparatus according to claim 1, wherein the apparatus body includes:
a moving portion configured to move the restricting member between the restricting position and the allowing position;
a toner remainder amount sensor configured to output a signal corresponding to a remainder amount of the toner stored in the toner cartridge; and
a controller configured to control the moving portion to move the restricting member to the allowing position in a case where a signal corresponding to the remainder amount of the toner of a predetermined amount or less is obtained from the toner remainder amount sensor.

8. The image forming apparatus according to claim 1, wherein the apparatus body includes:
an opening portion,
a door movable to a closed position where the door closes the opening portion and an open position where the door opens the opening portion;
a moving portion configured to move the restricting member between the restricting position and the allowing position;
a door sensor configured to output a signal differing between a case where the door is at the closed position and a case where the door is at the open position; and
a controller configured to control the moving portion to move the restricting member to the allowing position in a case where a signal corresponding to the case where the door is at the open position is obtained from the door sensor.

9. The image forming apparatus according to claim 1, wherein the apparatus body includes:
a moving portion configured to move the restricting member between the restricting position and the allowing position;
an operation portion configured to output a signal instructing to detach the toner cartridge from the apparatus body; and
a controller configured to control the moving portion to move the restricting member to the allowing position in a case where the signal is input from the operation portion.

10. The image forming apparatus according to claim 1, wherein the apparatus body includes:
an opening portion;
a door movable to a closed position where the door closes the opening portion and an open position where the door opens the opening portion; and
an interlocking portion configured to move the restricting member to the allowing position in conjunction with movement of the door from the closed position to the open position.

11. The image forming apparatus according to claim 1, wherein in a case of separating the toner cartridge from the apparatus body, engagement between the restricting member and the inlet port is released to open the inlet port before connection between the connecting portion and the discharge port is released.

12. The image forming apparatus according to claim 1, wherein the detachment direction is a direction along a horizontal direction, and
wherein the intersecting direction is a direction along a gravity direction.

13. An image forming apparatus comprising:
an apparatus body including:
a photosensitive drum configured to bear an electrostatic latent image;
a developing container configured to store toner; and
a developing roller configured to develop the electrostatic latent image into a toner image by using the toner in the developing container; and
a toner cartridge configured to be attachable to and detachable from the apparatus body, the toner cartridge including:
a toner storage chamber configured to store the toner and provided with a discharge port through which the toner is discharged to an outside of the toner cartridge;
a filter configured to suppress passage of the toner and allow passage of air; and
an air chamber partitioned from the toner storage chamber by the filter and provided with an inlet port communicating with the air chamber,
wherein the apparatus body includes:
a restricting member configured to, in a case where the toner cartridge is at an attached position where the toner cartridge is attached to the apparatus body, restrict movement of the toner cartridge in a detachment direction from the attached position by engaging with the inlet port of the toner cartridge;
a connecting portion connected to the discharge port in the case where the toner cartridge is at the attached position, the connecting portion being communicating with a first passage through which the toner discharged from the toner cartridge and conveyed to the developing container passes; and
a pump configured to supply the air to the air chamber of the toner cartridge through the inlet port and to discharge the toner in the toner storage chamber through the discharge port together with the air, and
wherein the restricting member includes a second passage through which the air supplied from the pump to the air chamber passes, and is separated from the inlet port to allow the movement of the toner cartridge in the detachment direction in response to movement of the toner cartridge in an intersecting direction intersecting with the detachment direction from the attached position.

14. The image forming apparatus according to claim 13, wherein the apparatus body includes:
an opening portion; and
a door movable to a closed position where the door closes the opening portion and an open position where the door opens the opening portion, and
wherein the toner cartridge includes a gripping portion provided on a surface, of the toner cartridge, facing in the detachment direction, and moves such that the inlet port is separated from the restricting member in response to operation of the gripping portion in the intersecting direction at the attached position.

15. The image forming apparatus according to claim 13, wherein the inlet port is separated from the restricting member in response to movement of the toner cartridge to a moved position to which the toner cartridge has been moved by a predetermined detachment distance in the intersecting direction from the attached position, and
wherein the apparatus body includes a restricting portion configured to restrict movement of the toner cartridge in the detachment direction in a case where the toner cartridge is positioned between the attached position and the moved position.

16. The image forming apparatus according to claim 15, wherein the restricting portion guides the toner cartridge moving in the detachment direction from the moved position.

17. The image forming apparatus according to claim 13, wherein in a case of separating the toner cartridge from the apparatus body, engagement between the restricting member and the inlet port is released to open the inlet port before connection between the connecting portion and the discharge port is released.

18. The image forming apparatus according to claim 13, wherein the detachment direction is a direction along a horizontal direction, and
wherein the intersecting direction is a direction along a gravity direction.
